(19) United States
(12) Patent Application Publication
(10) Pub. No.: US 2021/0081380 A1
(43) Pub. Date: Mar. 18, 2021

(54) Electronic Device, List Deduplication Method and Computer-Readable Storage Medium

(71) Applicant: PING AN TECHNOLOGY (SHENZHEN) CO., LTD., Shenzhen (CN)

(72) Inventors: Yi SHEN, Shenzhen (CN); Xun ZHANG, Shenzhen (CN); Gang WANG, Shenzhen (CN)

(73) Assignee: PING AN TECHNOLOGY (SHENZHEN) CO., LTD., Shenzhen (CN)

(21) Appl. No.: 16/089,385

(22) PCT Filed: Sep. 30, 2017
(86) PCT No.: PCT/CN2017/105025

§ 371 Date: Sep. 28, 2018

(30) Foreign Application Priority Data
Jul. 25, 2017 (CN) 201710614495.0

(51) Int. Cl. G06F 16/215; G06F 16/2455

(52) U.S. Cl. CPC G06F 16/215; G06F 16/24556

(57) ABSTRACT

An electronic device, a list deduplication method and a medium. The method includes: acquiring to-be-processed lists one by one from a database, and analyzing whether the acquired lists have first-type Identifiers (IDs); if the lists have the first-type IDs, looking up customer lists with same first-type IDs as the first-type IDs of the lists in a valid customer database; if the customer lists are not found, looking up customer lists with the same second-type IDs as those of the lists in the valid customer database; if the customer lists are found, checking whether the customer lists have first-type IDs; if the found customer lists have the first-type IDs, refreshing the found customer lists according database, and then comparing the second-type IDs of the lists with the second-type IDs of the customer lists; and if they are matched, deduplicating the lists to be processed.

### CROSS-REFERENCE TO RELATED APPLICATIONS

This application is the national phase entry of International Application No. PCT/CN2017/105025, filed on Sep. 30, 2017, which is based upon and claims priority to Chinese Patent Application No. CN201710614495.0, filed on Jul. 25, 2017, the entire contents of which are incorporated herein by reference.

### TECHNICAL FIELD

The present invention relates to the technical field of data processing, and particularly relates to an electronic device, a list deduplication method and a computer-readable storage medium.

### BACKGROUND

In a present list deduplication processing manner, deduplication is generally based on customer Identifier (ID) codes (for example, single ID codes like userId and customerId) or mobile phone numbers only; that is, if the lists with the same customer ID codes or mobile phone numbers are found out in a system, deduplication is performed, otherwise, the lists are saved. This deduplication manner may delete a customer list without updating it or store a large number of duplicate lists, thus failing to achieve the deduplication effect.

### SUMMARY

The present invention is mainly directed to provide a list deduplication method, so as to improve list deduplication accuracy.

A first aspect of the present invention provides an electronic device, which includes a memory and a processor, wherein a list deduplication system capable of running on the processor is stored in the memory, and the list deduplication system is executed by the processor to implement the steps of:

acquiring customer lists to be processed one by one from a database to be processed, and analyzing whether the acquired customer lists to be processed have first-type IDs or not;

if the customer lists to be processed have the first-type IDs, looking up customer lists of which first-type IDs are the same as the first-type IDs of the customer lists to be processed in a valid customer database;

if the customer lists of which the first-type IDs are the same as the first-type IDs of the customer lists to be processed are not found, looking up customer lists of which second-type IDs are the same as second-type IDs of the customer lists to be processed in the valid customer database;

if the customer lists of which the second-type IDs are the same as the second-type IDs of the customer lists to be processed are found, checking whether the found customer lists have first-type IDs or not;

if the found customer lists have the first-type IDs, refreshing the found customer lists according to the database to be processed, and then comparing the second-type IDs of the customer lists to be processed with the second-type IDs of the found customer lists;

and if the second-type IDs of the customer lists to be processed are the same as the second-type IDs of the found customer lists, deduplicating the customer lists to be processed.

A second aspect of the present invention provides a list deduplication method, which includes the steps of:

acquiring customer lists to be processed one by one from a database to be processed, and analyzing whether the acquired customer lists to be processed have first-type IDs or not;

if the customer lists to be processed have the first-type IDs, looking up customer lists of which first-type IDs are the same as the first-type IDs of the customer lists to be processed in a valid customer database;

if the customer lists of which the first-type IDs are the same as the first-type IDs of the customer lists to be processed are not found, looking up customer lists of which second-type IDs are the same as second-type IDs of the customer lists to be processed in the valid customer database;

if the customer lists of which the second-type IDs are the same as the second-type IDs of the customer lists to be processed are found, checking whether the found customer lists have first-type IDs or not;

if the found customer lists have the first-type IDs, refreshing the found customer lists according to the database to be processed, and then comparing the second-type IDs of the customer lists to be processed with the second-type IDs of the found customer lists;

and if the second-type IDs of the customer lists to be processed are the same as the second-type IDs of the found customer lists, deduplicating the customer lists to be processed.

A third aspect of the present invention provides a computer-readable storage medium, which stores an information query control system, wherein the information query control system may be executed by at least one processor to enable the at least one processor to execute the following operation:

acquiring customer lists to be processed one by one from a database to be processed, and analyzing whether the acquired customer lists to be processed have first-type IDs or not;

if the customer lists to be processed have the first-type IDs, looking up customer lists of which first-type IDs are the same as the first-type IDs of the customer lists to be processed in a valid customer database;

if the customer lists of which the first-type IDs are the same as the first-type IDs of the customer lists to be processed are not found, looking up customer lists of which second-type IDs are the same as second-type IDs of the customer lists to be processed in the valid customer database;

if the customer lists of which the second-type IDs are the same as the second-type IDs of the customer lists to be processed are found, checking whether the found customer lists have first-type IDs or not;

if the found customer lists have the first-type IDs, refreshing the found customer lists according to the database to be processed, and then comparing the second-type IDs of the customer lists to be processed with the second-type IDs of the found customer lists; and if the second-type IDs of the customer lists to be processed are the same as the second-type IDs of the found customer lists, deduplicating the customer lists to be processed.

According to the technical solutions of the present invention, whether the customer lists with the first-type IDs exist or not is judged by lookup through unique ID codes, i.e., the first-type IDs, in the customer lists to be processed at first, and when no customer lists are found through the first-type IDs, lookup is performed in the valid customer database through the second-type IDs in the customer lists to be processed; and after the customer lists with the same second-type IDs are found through the second-type IDs of the customer lists to be processed and the found customer lists have the first-type IDs, the found customer lists are refreshed according to the database to be processed, the second-type IDs of the refreshed customer lists are compared with the second-type IDs of the customer lists to be processed, and if the second-type IDs are still consistent, the present customer lists to be processed are deduplicated. Compared with the prior art, the solutions have multiple advantages that they can avoid both incomplete deduplication that may occur in an ID lookup-based deduplication manner and mistaken deduplication in a mobile phone number-based deduplication manner, thus improving a list deduplication effect and accuracy.

### BRIEF DESCRIPTION OF THE DRAWINGS

In order to describe the technical solutions in embodiments of the present invention or the prior art more clearly, the accompanying drawings required to be used in descriptions about the embodiments or the prior art will be simply introduced below. It is apparent that the accompanying drawings described below are only some embodiments of the present invention, and those of ordinary skilled in the art may also obtain other accompanying drawings according to these accompanying drawings without creative work.

FIG. 1 is a flowchart of a first embodiment of a list deduplication method according to the present invention;

FIG. 2 is a flowchart of a second embodiment of a list deduplication method according to the present invention;

FIG. 3 is a schematic diagram of a running environment of a first embodiment of a list deduplication system according to the present invention;

FIG. 4 is a program module diagram of a first embodiment of a list deduplication system according to the present invention;

FIG. 5 is a program module diagram of a second embodiment of a list deduplication system according to the present invention; and

FIG. 6 is a program module diagram of a third embodiment of a list deduplication system according to the present invention.

Achievement of purposes, functional characteristics and advantages of the present invention will be further described in combination with the embodiments and with reference to the accompanying drawings.

### DETAILED DESCRIPTION OF THE EMBODIMENTS

Principles and characteristics of the present invention will be described below in combination with the accompanying drawings. Examples are listed only to explain the present invention and not intended to limit the scope of the present invention.

The present invention discloses a list deduplication method.

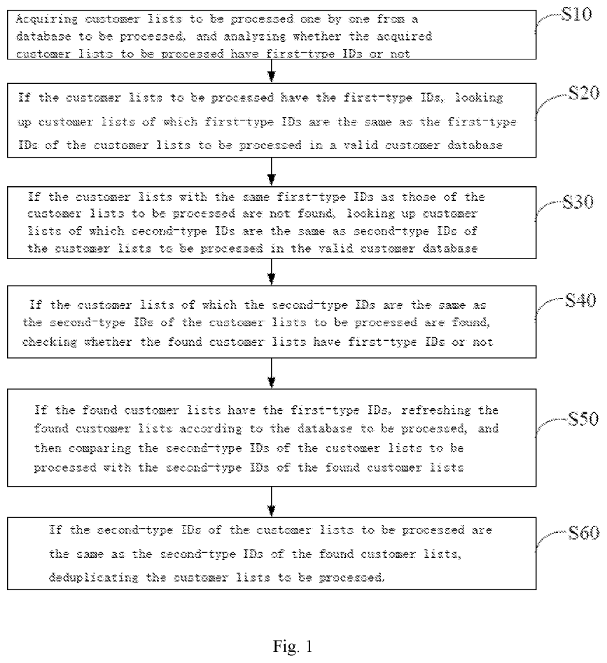

As shown in FIG. 1, FIG. 1 is a flowchart of a first embodiment of a list deduplication method according to the present invention.

In the embodiment, the list deduplication method includes the steps of:

In Step S10, customer lists to be processed are acquired one by one from a database to be processed, and whether the acquired customer lists to be processed have first-type IDs or not is analyzed.

In the embodiment, the customer lists to be processed refer to lists generated by a service system during operation and recording customer data, all of newly generated customer lists to be processed are saved in the database to be processed, and a list deduplication system regularly processes the customer lists to be processed in the database to be processed. A customer list to be processed may include a first-type ID (for example, a username and a register name), a second-type ID (for example, a register mobile phone number and a register ID number) and a third-type ID (for example, a frequently used contact number), wherein the first-type ID is a unique ID code of a customer. In the embodiment, part of customer lists in the database to be processed may have no first-type IDs and part of customer lists may even have no first-type IDs and second-type IDs. Preferably, in the embodiment, the first-type ID is a user ID, the second-type ID is a register mobile phone number, the third-type ID is a frequently used contact number, and there may be multiple third-type IDs. In the embodiment, the list deduplication system acquires the customer lists to be processed in the database to be processed in a one-by-one acquisition manner and checks whether the acquired customer lists to be processed have the first-type IDs or not at first.

In Step S20, if the customer lists to be processed have the first-type IDs, customer lists of which first-type IDs are the same as the first-type IDs of the customer lists to be processed are looked up in a valid customer database.

After confirming that the customer lists to be processed have the first-type IDs, the list deduplication system looks up the customer lists of which the first-type IDs are the same as the first-type IDs of the customer lists to be processed in the valid customer database to determine whether the customer lists with the same first-type IDs have been in existence in the valid customer database or not. If the customer lists of which the first-type IDs are the same as the first-type IDs of the customer lists to be processed are found in the valid customer database, since the first-type IDs are unique ID codes of customers, which indicates that the found customer lists and the customer lists to be processed record data of the same customers, and the customer lists to be processed record latest related data of the customers, the list deduplication system may update the found customer lists according to the customer lists to be processed to save the latest data of the customer lists with the first-type IDs in the valid customer database.

In Step S30, if the customer lists with the same first-type IDs as those of the customer lists to be processed are not found, customer lists of which second-type IDs are the same as second-type IDs of the customer lists to be processed are looked up in the valid customer database.

If the list deduplication system does not find the customer lists of which the first-type IDs are the same as the first-type IDs of the customer lists to be processed in the valid customer database, since customer lists without first-type IDs are also saved in the valid database, it may not be confirmed at this moment that there are no customer lists with duplicate data in the customer lists to be processed in the valid customer database. Therefore, the list deduplication system further performs lookup through the second-type IDs, namely looking up the customer lists of which the second-type IDs are the same as the second-type IDs of the customer lists to be processed in the valid customer database, to confirm whether the second-type IDs in the customer lists to be processed have been registered or not.

In Step S40, if the customer lists of which the second-type IDs are the same as the second-type IDs of the customer lists to be processed are found, whether the found customer lists have first-type IDs or not is checked.

When the list deduplication system finds the customer lists of which the second-type IDs are the same as the second-type IDs of the customer lists to be processed in the valid customer database, it is indicated that the second-type IDs have been registered, and at this moment, whether the found customer lists have the first-type IDs or not is checked to confirm whether the second-type IDs have been registered by other first-type IDs or not. If the list deduplication system finds no first-type IDs from the found customer lists, it may be confirmed according to the same second-type IDs of them that the found customer lists and the customer lists to be processed record data of the same customers, at this moment, the list deduplication system updates the found customer lists according to the data of the customer lists to be processed, namely saving data of the customer lists to be processed in the found customer lists, and the found customer lists have the first-type IDs after being updated.

In Step S50, if the found customer lists have the first-type IDs, the found customer lists are refreshed according to the database to be processed, and then the second-type IDs of the customer lists to be processed are compared with the second-type IDs of the found customer lists.

When the list deduplication system finds the first-type IDs from the found customer lists and the list deduplication system does not find the customer lists with the same first-type IDs during lookup in the valid database through the first-type IDs of the customer lists to be processed at first, it is indicated that the first-type IDs of the customer lists found through the second-type IDs of the customer lists to be processed are different from the first-type IDs of the customer lists to be processed, that is, the case that one second-type ID corresponds to two first-type IDs occurs, and this case is not allowed. This case may be caused by the following reasons: 1: since the data of the customer lists in the valid customer database are not the latest, the customers in the found customer lists may have deregistered the second-type IDs and the second-type IDs may be used by others at present; 2: the customers with the second-type IDs register by using the second-type IDs and with different first-type IDs; and 3: the second-type IDs are used by others for registration as second-type IDs. When this case occurs, in order to confirm the specific reason, the list deduplication system refreshes the found customer lists according to the database to be processed to ensure that second-type ID data in the found customer lists are the latest and then compares the second-type IDs of the found customer lists with the second-type IDs of the customer lists to be processed.

In Step S60, if the second-type IDs of the customer lists to be processed are the same as the second-type IDs of the found customer lists, deduplicating the customer lists to be processed.

After the found customer lists are refreshed, the second-type IDs are still consistent with the second-type IDs of the customer lists to be processed, and it is indicated that the second-type IDs of the customer lists to be processed have been registered by the first-type IDs of the found customer lists, the second-type IDs are still being used by the first-type IDs of the found customer lists and other first-type IDs are not allowed to use the second-type IDs for duplicate registration, so that the list duplication system deduplicates the customer lists to be processed, namely deleting the customer lists to be processed.

According to the technical solution of the embodiment, whether the customer lists with the first-type IDs exist or not is judged by lookup in the valid customer database through unique ID codes, i.e., the first-type IDs, in the customer lists to be processed at first, and when no customer lists are found through the first-type IDs, lookup is performed in the valid customer database through the second-type IDs in the customer lists to be processed; and after the customer lists with the same second-type IDs are found through the second-type IDs of the customer lists to be processed and the found customer lists have the first-type IDs, the found customer lists are refreshed according to the database to be processed, the second-type IDs of the refreshed customer lists are compared with the second-type IDs of the customer lists to be processed, and if the second-type IDs are still consistent, the present customer lists to be processed are deduplicated. Compared with the prior art, the solutions have multiple advantages that they can avoid both incomplete deduplication that may occur in an ID lookup-based deduplication manner and mistaken deduplication in a mobile phone number-based deduplication manner, thus improving a list deduplication effect and accuracy.

Preferably, the step in Step S50 that the found customer lists are refreshed according to the database to be processed includes that:

the customer lists to be processed of which the first-type IDs are the same as the first-type IDs of the found customer lists are matched in the database to be processed, wherein, since the latest customer data are saved in the database to be processed, the list deduplication system matches the customer lists to be processed with the same first-type IDs in the database to be processed through the first-type IDs of the found customer lists to find the latest data of the customers with the first-type IDs; and after the matched customer lists to be processed are found, the found customer lists are updated according to the matched customer lists to be processed.

If the customer lists to be processed with the same first-type IDs as those of the found customer lists exist in the database to be processed, the list deduplication system, after finding the matched customer lists to be processed with the first-type IDs, updates the found customer lists according to the data of the matched customer lists to be processed to ensure that data in the found customer lists are the latest, namely updating the second-type IDs. In addition, if the customer lists to be processed with the same first-type IDs as those of the found customer lists do not exist in the database to be processed, the data of the found customer lists are kept unchanged.

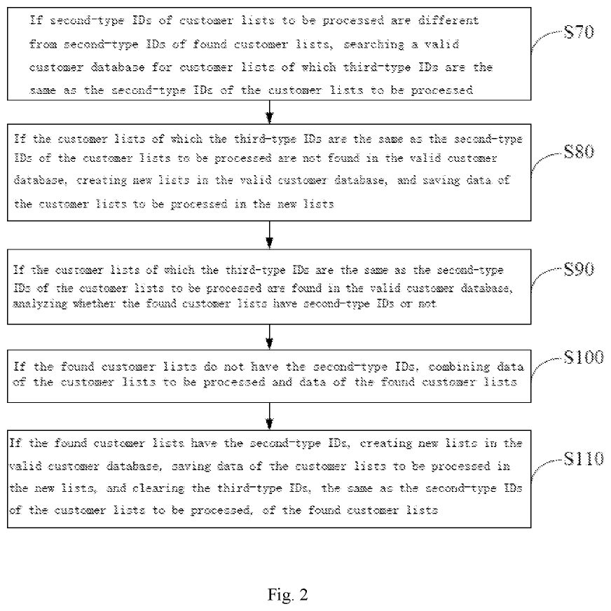

As shown in FIG. 2, FIG. 2 is a flowchart of a second embodiment of a list deduplication method according to the present invention. The embodiment is based on the solution of the first embodiment. In the embodiment, after Step S50, the list deduplication method further includes the steps of.

In Step S70, if the second-type IDs of the customer lists to be processed are different from the second-type IDs of the found customer lists, the valid customer database is searched for customer lists of which third-type IDs are the same as the second-type IDs of the customer lists to be processed.

After the found customer lists are refreshed, if their second-type IDs become inconsistent with the second-type IDs of the customer lists to be processed, it is indicated that the found customer lists have changed the second-type IDs and their original second-type IDs have been deregistered, so that the second-type IDs in the customer lists to be processed do not conflict with second-type IDs of customer lists in the valid customer database, and the second-type IDs of the customer lists to be processed are valid; and at this moment, the list deduplication system further searches the valid customer database for the customer lists of which the third-type IDs are the same as the second-type IDs of the customer lists to be processed.

In Step S80, if the customer lists of which the third-type IDs are the same as the second-type IDs of the customer lists to be processed are not found in the valid customer database, new lists are created in the valid customer database, and data of the customer lists to be processed are saved in the new lists.

If the list deduplication system does not find the third-type IDs the same as the second-type IDs of the customer lists to be processed in the valid customer database, there are no customer lists associated with the second-type IDs of the customer lists to be processed in the valid customer database, the customer lists to be processed are confirmed to be new lists, and the list deduplication system creates the new lists in the valid customer database and saves the data of the customer lists to be processed in the new lists to form customer lists newly added in the valid customer database, and deletes the customer lists to be processed.

In Step S90, if the customer lists of which the third-type IDs are the same as the second-type IDs of the customer lists to be processed are found in the valid customer database, whether the found customer lists have second-type IDs or not is analyzed.

When the list deduplication system finds the customer lists of which the third-type IDs include the second-type IDs of the customer lists to be processed, whether the found customer lists have the second-type IDs or not is further checked.

In Step S100, if the found customer lists do not have the second-type IDs, data of the customer lists to be processed and data of the found customer lists are combined.

When the found customer lists do not have the second-type IDs, it is indicated that data of the found customer lists are not data of registered customers and the data of the found customer lists are associated with the data of the customer lists to be processed. Therefore, data of found customer lists and data of the customer lists to be processed are combined to form latest customer lists, that is, data of the customer lists to be processed are added into the found customer lists, and the customer lists to be processed is deleted.

In Step S110, if the found customer lists have the second-type IDs, new lists are created in the valid customer database, data of the customer lists to be processed are saved in the new lists, and the third-type IDs, the same as the second-type IDs of the customer lists to be processed, of the found customer lists are cleared.

When the found customer lists have the second-type IDs, it is indicated that the customer lists to be processed and the found customer lists record data of different customers respectively. Since the third-type IDs, the same as the second-type IDs of the customer lists to be processed, in the found customer lists have been used as the second-type IDs of the customer lists to be processed at present, the third-type IDs in the found customer lists should be deleted. Such a case may be caused by a reason that the third-type IDs have already been deregistered by customers and the data have yet not been updated. At this moment, the list deduplication system saves data of the customer lists to be processed in the new lists in the valid customer database to form new customer lists and clears the third-type IDs, the same as the second-type IDs of the customer lists to be processed, in the found customer lists to update the found customer lists.

Furthermore, after Step S10, the list deduplication method of the embodiment further includes that:

if the customer lists to be processed do not have the first-type IDs, customer lists of which second-type IDs or third-type IDs are the same as the second-type IDs or third-type IDs of the customer lists to be processed are looked up in the valid customer database,

wherein, when the list deduplication system determines that the customer lists to be processed do not have the first-type IDs, the customer lists including the second-type IDs or third-type IDs of the customer lists to be processed are looked up in the valid customer database to determine whether the data of the customer lists to be processed without the first-type IDs exist in the valid customer database or not;

if the customer lists with the same second-type IDs or third-type IDs of the customer lists to be processed are not found, new lists are created in the valid customer database, and data in the customer lists to be processed are saved in the new lists,

wherein, if the list deduplication system does not find the customer lists with the same second-type IDs or third-type IDs as those of the customer lists to be processed in the valid customer database, it is indicated that the second-type IDs and third-type IDs of the customer lists to be processed do not exist in the valid customer database, that is, the customer lists to be processed record new customer information, and at this moment, the list deduplication system creates the new lists in the valid customer database, saves all of the data of the customer lists to be processed in the new lists and deletes the customer lists to be processed, namely newly adding customer lists without first-type IDs in the valid customer database; and

if the customer lists with the same second-type IDs or third-type IDs as those of the customer lists to be processed are found, the customer lists to be processed are deduplicated,

wherein, when the list deduplication system finds the customer lists with the same second-type IDs or third-type IDs as those of the customer lists to be processed in the valid customer database, it is indicated that the data of the customer lists to be processed exist in the valid customer database, and since the customer lists to be processed do not have the first-type IDs, it is unnecessary to save the lists having no first-type IDs and recording duplicate data of the customer lists in the valid customer database and thus the list deduplication system directly deletes the customer lists to be processed.

The present invention further discloses a list deduplication system.

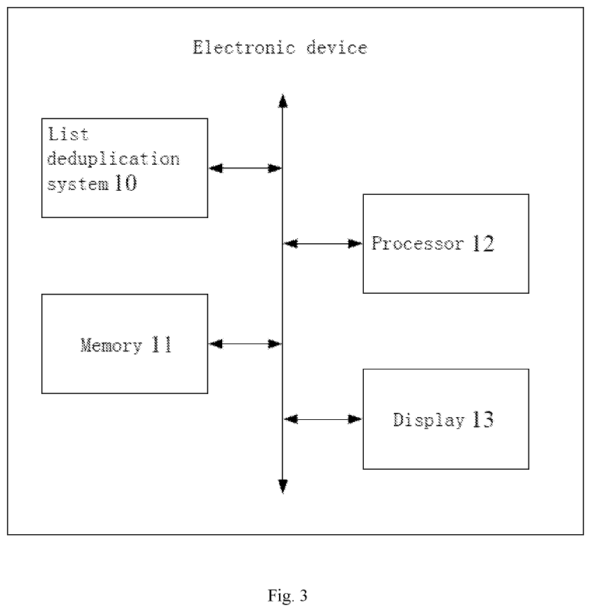

Referring to FIG. 3, a schematic diagram of a running environment of a preferred embodiment of a list deduplication system 10 according to the present invention is shown.

In the embodiment, the list deduplication system 10 is installed and runs in an electronic device 1. The electronic device 1 may be computing equipment such as a desktop computer, a notebook computer, a palm computer and a server. The electronic device 1 may include, but not limited to, a memory 11, a processor 12 and a display 13. Only the electronic device 1 with the components 11-13 is shown in FIG. 3. However, it should be understood that not all of the shown components are required to be implemented and more or fewer components may be implemented instead.

In some embodiments, the memory 11 may be an internal storage unit of the electronic device 1, for example, a hard disk or internal memory of the electronic device 1; and in some other embodiments, the memory 11 may also be external storage equipment of the electronic device 1, for example, a plug-in type hard disk, Smart Media Card (SMC), Secure Digital (SD) card and flash card configured on the electronic device 1. Furthermore, the memory 11 may also not only include the internal storage unit of the electronic device 1 but also include the external storage equipment. The memory 11 is configured to store application software installed in the electronic device 1 and various types of data, for example, a program code of the list deduplication system 10. The memory 11 may further be configured to temporally store data which have been output or will be output.

The processor 12, in some embodiments, may be a Central Processing Unit (CPU), a microprocessor or another data processing chip, and is configured to run the program code or process data stored in the memory 11, for example, executing the list deduplication system 10.

In some embodiments, the display 13 may be a Light-Emitting Diode (LED) display, a liquid crystal display, a touch liquid crystal display, an Organic Light-Emitting Diode (OLED) touch display and the like. The display 13 is configured to display data processed in the electronic device 1 and configured to display a visual user interface, for example, a service customization interface. The components 11-13 of the electronic device 1 communicate with one another through a system bus.

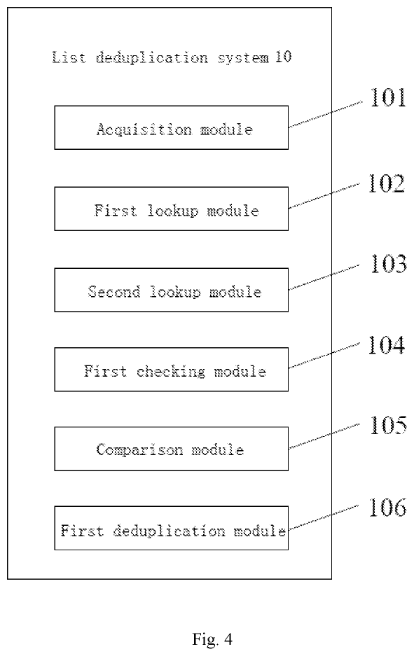

Referring to FIG. 4, a program module block of a first embodiment of a list deduplication system 10 according to the present invention is shown. In the embodiment, the list deduplication system 10 may be divided into one or more modules, and the one or more modules are stored in a memory 11 and executed by one or more processors (a processor 12 in the embodiment) to implement the present invention. For example, in FIG. 4, the list deduplication system 10 may be divided into an acquisition module 101, a first lookup module 102, a second lookup module 103, a first checking module 104, a comparison module 105 and a first deduplication module 106. The modules mentioned in the present invention refer to a series of computer program instruction segments capable of realizing specific functions and are more suitable for describing an execution process of the list deduplication system 10 in an electronic device 1 in comparison with programs, wherein the acquisition module 101 is configured to acquire customer lists to be processed one by one from a database to be processed and analyze whether the acquired customer lists to be processed have first-type IDs or not.

In the embodiment, the customer lists to be processed refer to lists generated by a service system during operation and recording customer data, all of newly generated customer lists to be processed are saved in the database to be processed, and the list deduplication system 10 regularly processes the customer lists to be processed in the database to be processed. A customer list to be processed may include a first-type ID (for example, a username and a register name), a second-type ID (for example, a register mobile phone number and a register ID number) and a third-type ID (for example, a frequently used contact number), wherein the first-type ID is a unique ID code of a customer. In the embodiment, part of customer lists in the database to be processed may have no first-type IDs and part of customer lists may even have no first-type IDs and second-type IDs. Preferably, in the embodiment, the first-type ID is a user ID, the second-type ID is a register mobile phone number, the third-type ID is a frequently used contact number, and there may be multiple third-type IDs. In the embodiment, the list deduplication system 10 acquires the customer lists to be processed in the database to be processed in a one-by-one acquisition manner and checks whether the acquired customer lists to be processed have the first-type IDs or not at first.

The first lookup module 102 is configured to, after it is determined that the customer lists to be processed have the first-type IDs, look up customer lists of which first-type IDs are the same as the first-type IDs of the customer lists to be processed in a valid customer database.

After confirming that the customer lists to be processed have the first-type IDs, the list deduplication system 10 looks up the customer lists of which the first-type IDs are the same as the first-type IDs of the customer lists to be processed in the valid customer database to determine whether the customer lists with the same first-type IDs have been in existence in the valid customer database or not. If the customer lists of which the first-type IDs are the same as the first-type IDs of the customer lists to be processed are found in the valid customer database, since the first-type IDs are unique ID codes of customers, which indicates that the found customer lists and the customer lists to be processed record data of the same customers, and the customer lists to be processed record latest related data of the customers, the list deduplication system 10 may update the found customer lists according to the customer lists to be processed to save the latest data of the customer lists with the first-type IDs in the valid customer database.

The second lookup module 103 is configured to, if the customer lists with the same first-type IDs as those of the customer lists to be processed are not found, look up customer lists of which second-type IDs are the same as second-type IDs of the customer lists to be processed in the valid customer database.

If the list deduplication system 10 does not find the customer lists of which the first-type IDs are the same as the first-type IDs of the customer lists to be processed in the valid customer database, since customer lists without first-type IDs are also saved in the valid database, it may not be confirmed at this moment that there are no customer lists with duplicate data of the customer lists to be processed in the valid customer database. Therefore, the list deduplication system 10 further performs lookup through the second-type IDs, namely looking up the customer lists of which the second-type IDs are the same as the second-type IDs of the customer lists to be processed in the valid customer database, to confirm whether the second-type IDs in the customer lists to be processed have been registered or not.

The first checking module 104 is configured to, after the customer lists of which the second-type IDs are the same as the second-type IDs of the customer lists to be processed are found, check whether the found customer lists have first-type IDs or not.

When the list deduplication system finds the customer lists of which the second-type IDs are the same as the second-type IDs of the customer lists to be processed in the valid customer database, it is indicated that the second-type IDs have been registered, and at this moment, whether the found customer lists have the first-type IDs or not is checked to confirm whether the second-type IDs have been registered by other first-type IDs or not. If the list deduplication system 10 finds no first-type IDs from the found customer lists, it may be confirmed according to the same second-type IDs of them that the found customer lists and the customer lists to be processed record data of the same customers, at this moment, the list deduplication system 10 updates the found customer lists according to the data of the customer lists to be processed, namely saving the data of the customer lists to be processed in the found customer lists, and the found customer lists have the first-type IDs after being updated.

The comparison module 105 is configured to, if the found customer lists have the first-type IDs, refresh the found customer lists according to the database to be processed and then compare the second-type IDs of the customer lists to be processed with the second-type IDs of the found customer lists.

When the list deduplication system 10 finds the first-type IDs from the found customer lists and the list deduplication system 10 does not find the customer lists with the same first-type IDs during lookup in the valid database through the first-type IDs of the customer lists to be processed at first, it is indicated that the first-type IDs of the customer lists found through the second-type IDs of the customer lists to be processed are different from the first-type IDs of the customer lists to be processed, that is, the case that one second-type ID corresponds to two first-type IDs occurs, and this case is not allowed. This case may be caused by the following reasons: 1: since the data of the customer lists in the valid customer database are not the latest, the customers of the found customer lists may have deregistered the second-type IDs and the second-type IDs may be used by others at present; 2: the customers with the second-type IDs register by using the second-type IDs and with different first-type IDs; and 3: the second-type IDs are used by others for registration as second-type IDs. When this case occurs, in order to confirm the specific reason, the list deduplication system 10 refreshes the found customer lists according to the database to be processed to ensure that second-type ID data in the found customer lists are the latest and then compares the second-type IDs of the found customer lists with the second-type IDs of the customer lists to be processed.

The first deduplication module 106 is configured to, after the second-type IDs of the customer lists to be processed are matched with the second-type IDs of the found customer lists, deduplicate the customer lists to be processed.

After the found customer lists are refreshed, the second-type IDs are still consistent with the second-type IDs of the customer lists to be processed, and it is indicated that the second-type IDs of the customer lists to be processed have been registered by the first-type IDs of the found customer lists, the second-type IDs are still being used by the first-type IDs of the found customer lists and other first-type IDs are not allowed to use the second-type IDs for duplicate registration, so that the list duplication system deduplicates the customer lists to be processed, namely deleting the customer lists to be processed.

According to the technical solution of the embodiment, whether the customer lists with the first-type IDs exist or not is judged by lookup in the valid customer database through unique ID codes, i.e., the first-type IDs, in the customer lists to be processed at first, and when no customer lists are found through the first-type IDs, lookup is performed in the valid customer database through the second-type IDs in the customer lists to be processed; and after the customer lists with the same second-type IDs are found through the second-type IDs of the customer lists to be processed and the found customer lists have the first-type IDs, the found customer lists are refreshed according to the database to be processed, the second-type IDs of the refreshed customer lists are compared with the second-type IDs of the customer lists to be processed, and if the second-type IDs are still consistent, the present customer lists to be processed are deduplicated. Compared with the prior art, the solutions have multiple advantages that they can avoid both incomplete deduplication that may occur in an ID lookup-based deduplication manner and mistaken deduplication in a mobile phone number-based deduplication manner, thus improving a list deduplication effect and accuracy.

In the embodiment, the operation that the comparison module 105 refreshes the found customer lists according to the database to be processed is specifically implemented by: matching the customer lists to be processed of which the first-type IDs are the same as the first-type IDs of the found customer lists in the database to be processed; and after finding the matched customer lists to be processed, updating the found customer lists according to the matched customer lists to be processed.

Since the latest customer data are saved in the database to be processed, the comparison module 105 matches the customer lists to be processed with the same first-type IDs in the database to be processed through the first-type IDs of the found customer lists to find the latest data of the customers with the first-type IDs. If the customer lists to be processed with the same first-type IDs of the found customer lists exist in the database to be processed, the comparison module 105, after finding the matched customer lists to be processed with the first-type IDs, updates the found customer lists according to the data in the matched customer lists to be processed to ensure that data in the found customer lists are the latest, namely updating the second-type IDs. In addition, if the customer lists to be processed with the same first-type IDs of the found customer lists do not exist in the database to be processed, the data of the found customer lists are kept unchanged.

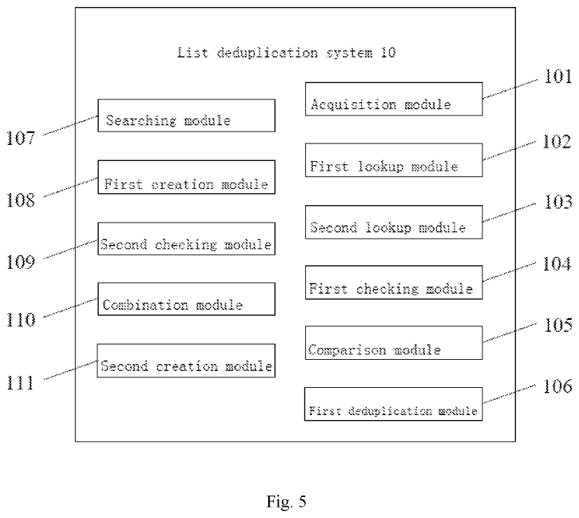

Referring to FIG. 5, the list deduplication system 10 of the embodiment further includes:

a searching module 107, configured to, if the second-type IDs of the customer lists to be processed are different from the second-type IDs of the found customer lists, search the valid customer database for customer lists of which third-type IDs are the same as the second-type IDs of the customer lists to be processed.

After the found customer lists are refreshed, if their second-type IDs become inconsistent with the second-type IDs of the customer lists to be processed, it is indicated that the found customer lists have changed the second-type IDs and their original second-type IDs have been deregistered, so that the second-type IDs in the customer lists to be processed do not conflict with second-type IDs of customer lists in the valid customer database, and the second-type IDs of the customer lists to be processed are valid; and at this moment, the list deduplication system 10 further searches the valid customer database for the customer lists of which the third-type IDs are the same as the second-type IDs of the customer lists to be processed.

A first creation module 108 is configured to, if the customer lists of which the third-type IDs are the same as the second-type IDs of the customer lists to be processed are not found in the valid customer database, create new lists in the valid customer database and save data in the customer lists to be processed in the new lists.

If the list deduplication system 10 does not find the third-type IDs the same as the second-type IDs of the customer lists to be processed in the valid customer database, there are no customer lists associated with the second-type IDs of the customer lists to be processed in the valid customer database, the customer lists to be processed are confirmed to be new lists, and the list deduplication system 10 creates the new lists in the valid customer database and saves the data of the customer lists to be processed in the new lists to form customer lists newly added in the valid customer database, and deletes the customer lists to be processed.

A second checking module 109 is configured to, after the customer lists of which the third-type IDs are the same as the second-type IDs of the customer lists to be processed are found in the valid customer database, analyze whether the found customer lists have second-type IDs or not.

When the list deduplication system 10 finds the customer lists of which the third-type IDs include the second-type IDs of the customer lists to be processed, whether the found customer lists have the second-type IDs or not is further checked.

A combination module 110 is configured to, after it is determined that the found customer lists do not have the second-type IDs, combine data of the customer lists to be processed and data of the found customer lists.

When the found customer lists do not have the second-type IDs, it is indicated that data of the found customer lists are not data of registered customers and the data of the found customer lists are associated with the data of the customer lists to be processed. Therefore, data of the found customer lists and data of the customer lists to be processed are combined to form latest customer lists, that is, the data in the customer lists to be processed are added into the found customer lists, and the customer lists to be processed is deleted.

A second creation module 111 is configured to, after it is determined that the found customer lists have the second-type IDs, create new lists in the valid customer database, save data the customer lists to be processed in the new lists and clear the third-type IDs, the same as the second-type IDs of the customer lists to be processed, of the found customer lists.

When the found customer lists have the second-type IDs, it is indicated that the customer lists to be processed and the found customer lists record data of different customers respectively. Since the third-type IDs, the same as the second-type IDs of the customer lists to be processed, in the found customer lists have been used as the second-type IDs of the customer lists to be processed at present, the third-type IDs in the found customer lists should be deleted. Such a case may be caused by a reason that the third-type IDs have already been deregistered by customers and the data have yet not been updated. At this moment, the list deduplication system 10 saves data of the customer lists to be processed in the new lists in the valid customer database to form new customer lists and clears the third-type IDs, the same as the second-type IDs of the customer lists to be processed, in the found customer lists to update the found customer lists.

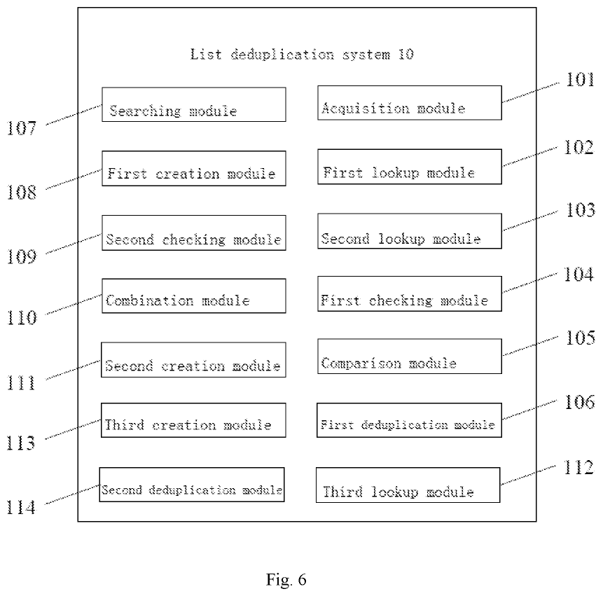

Referring to FIG. 6, the list deduplication system 10 of the embodiment further includes:

a third lookup module 112, configured to, when the customer lists to be processed do not have the first-type IDs, look up customer lists of which second-type IDs or third-type IDs are the same as the second-type IDs or third-type IDs of the customer lists to be processed in the valid customer database,

wherein, when the list deduplication system 10 determines that the customer lists to be processed do not have the first-type IDs, the valid customer database is searched for the customer lists including the second-type IDs or third-type IDs of the customer lists to be processed to determine whether the data of the customer lists to be processed without the first-type IDs exist in the valid customer database or not;

a third creation module 113, configured to, when the customer lists with the same second-type IDs or third-type IDs of the customer lists to be processed are not found, create new lists in the valid customer database and save data of the customer lists to be processed in the new lists,

wherein, if the list deduplication system 10 does not find the customer lists with the same second-type IDs or third-type IDs of the customer lists to be processed in the valid customer database, it is indicated that the second-type IDs and third-type IDs of the customer lists to be processed do not exist in the valid customer database, that is, the customer lists to be processed record new customer data, and at this moment, the list deduplication system 10 creates the new lists in the valid customer database and saves data of the customer lists to be processed in the new lists, namely newly adding customer lists without first-type IDs in the valid customer database; and

a second deduplication module 114, configured to, after the customer lists with the same second-type IDs or third-type IDs of the customer lists to be processed are found, deduplicate the customer lists to be processed,

wherein, when the list deduplication system 10 finds the customer lists with the same second-type IDs or third-type IDs of the customer lists to be processed in the valid customer database, it is indicated that the data of the customer lists to be processed exist in the valid customer database, and since the customer lists to be processed do not have the first-type IDs, it is unnecessary to save the lists having no first-type IDs and recording duplicate data of the customer lists in the valid customer database and the list deduplication system 10 directly deletes the customer lists to be processed.

The present invention further discloses a computer-readable storage medium, which stores an information query control system, wherein the information query control system may be executed by at least one processor to allow the at least one processor to execute the list deduplication method in any foregoing embodiment.

The above is only the preferred embodiment of the present invention and not thus intended to limit the patent scope of the present invention. Any equivalent structural transformations made by virtue of the contents of the specification and accompanying drawings of the present invention or their direct/indirect application to other related technical fields under the inventive concept of the present invention shall also fall within the scope of patent protection of the present invention.

1. An electronic device comprising a memory and a processor, wherein a list deduplication system capable of running on the processor is stored in the memory, and the list deduplication system is executed by the processor to implement the following steps:
step A1: acquiring to-be-processed customer lists one by one from a to-be-processed database, and analyzing whether the to-be-processed customer lists have first-type Identifiers (IDs) or not;
step B1: if the to-be-processed customer lists have the first-type IDs, looking up first customer lists, wherein the first-type Ids of the first customer lists are the same as the first-type IDs of the to-be-processed customer lists in a valid customer database;
step C1: if the first customer lists are not found, looking up second customer lists, wherein second-type IDs of the second customer lists are the same as second-type IDs of the to-be-processed customer lists in the valid customer database;
step D1: if the second customer lists are found, checking whether the second customer lists have the first-type IDs or not;
step E1: if the second customer lists have the first-type IDs, refreshing the second customer lists according to the to-be-processed database, and then comparing the second-type IDs of the to-be-processed customer lists with the second-type IDs of the second customer lists; and
step F1: if the second-type IDs of the to-be-processed customer lists are the same as the second-type IDs of the second customer lists, deduplicating the to-be-processed customer lists.

2. The electronic device of claim 1, wherein the step of refreshing the second customer lists according to the to-be-processed database comprises:
matching a first to-be-processed customer lists; wherein the first-type IDs of the first to-be-processed are the same as the first-type IDs of the second customer lists in the to-be-processed database; and
after finding the first to-be-processed customer lists, updating the second customer lists according to the first to-be-processed customer lists.

3. The electronic device of claim 1, wherein, after step E1, the processor is further configured to execute the list deduplication system to implement the following steps:
if the second-type IDs of the to-be-processed customer lists are different from the second-type IDs of the second customer lists, searching the valid customer database for third customer lists, wherein third-type IDs of the third customer lists are the same as the second-type IDs of the to-be-processed customer lists;
if the third customer lists are not found in the valid customer database, creating first new lists in the valid customer database, and saving data of the to-be-processed customer lists in the first new lists;
if the third customer lists are found in the valid customer database, analyzing whether the third customer lists have second-type IDs or not;
if the third customer lists do not have the second-type IDs, combining data of the to-be-processed customer lists and data of the third customer lists; and
if the third customer lists have the second-type IDs, creating second new lists in the valid customer database, saving data of the to-be-processed customer lists in the second new lists, and clearing the third-type IDs of the third customer lists.

4. The electronic device of claim 3, wherein the step of refreshing the second customer lists according to the to-be-processed database comprises:
matching a first to-be-processed customer lists; wherein the first-type IDs of the first to-be-processed are the same as the first-type IDs of the second customer lists in the to-be-processed database; and
after finding the first to-be-processed customer lists, updating the second customer lists according to the first to-be-processed customer lists.

5. The electronic device of claim 1, wherein, after step A1, the processor is further configured to execute the list deduplication system to implement the following steps:
if the to-be-processed customer lists do not have the first-type IDs, looking up fourth customer lists, wherein second-type IDs or third-type IDs of the fourth customer lists are the same as the second-type IDs of the to-be-processed customer lists or third-type IDs of the to-be-processed customer lists in the valid customer database;
if the fourth customer lists are not found, creating third new lists in the valid customer database, and saving the data of the to-be-processed customer lists in the new lists; and
if the fourth customer lists are found, deduplicating the to-be-processed customer lists.

6. The electronic device of claim 5, wherein the step of refreshing the second customer lists according to the to-be-processed database comprises:
matching first to-be-processed customer lists; wherein the first-type IDs of the first to-be-processed customer lists are the same as the first-type IDs of the second customer lists in the to-be-processed database; and
after finding the first to-be-processed customer lists, updating the second customer lists according to the first to-be-processed customer lists.

7. The electronic device of claim 1, wherein, after step D1, the processor is further configured to execute the list deduplication system to implement the following step:
if the second customer lists do not have the first-type IDs, updating the second customer lists according to the data of the to-be-processed database.

8. The electronic device of claim 7, wherein the step of refreshing the second customer lists according to the to-be-processed database comprises:
matching the first to-be-processed customer lists; wherein the first-type IDs of the first to-be-processed customer lists are the same as the first-type IDs of the second customer lists in the to-be-processed database; and
after finding the first to-be-processed customer lists, updating the second customer lists according to the first to-be-processed customer lists.

9. A list deduplication method, comprising the following steps:
step A2: acquiring to-be-processed customer lists one by one from a to-be-processed database, and analyzing whether the to-be-processed customer lists have first-type Identifiers (IDs) or not;
step B2: if the to-be-processed customer lists have the first-type IDs, looking up first customer lists, wherein the first-type Ids of the first customer lists are the same as the first-type IDs of the to-be-processed customer lists in a valid customer database;
step C2: if the first customer lists are not found, looking up second customer lists, wherein second-type IDs of the second customer lists are the same as second-type IDs of the to-be-processed customer lists in the valid customer database;
step D2: if the second customer lists are found, checking whether the second customer lists have the first-type IDs or not;
step E2: if the second customer lists have the first-type IDs, refreshing the second customer lists according to the to-be-processed database, and then comparing the second-type IDs of the to-be-processed customer lists with the second-type IDs of the second customer lists; and
step F1: if the second-type IDs of the to-be-processed customer lists are the same as the second-type IDs of the second customer lists, deduplicating the to-be-processed customer lists.

10. The list deduplication method of claim 9, wherein the step of refreshing the second customer lists according to the to-be-processed database comprises:
matching a first to-be-processed customer lists; wherein the first-type IDs of the first to-be-processed are the same as the first-type IDs of the second customer lists in the to-be-processed database; and
after finding the first to-be-processed customer lists, updating the second customer lists according to the first to-be-processed customer lists.

11. The list deduplication method of claim 9, further comprising, after step E2, the following steps:
if the second-type IDs of the to-be-processed customer lists are different from the second-type IDs of the second customer lists, searching the valid customer database for third customer lists, wherein third-type IDs of the third customer lists are the same as the second-type IDs of the to-be-processed customer lists;
if the third customer lists are not found in the valid customer database, creating first new lists in the valid customer database, and saving data of the to-be-processed customer lists in the first new lists;
if the third customer lists are found in the valid customer database, analyzing whether the third customer lists have second-type IDs or not;
if the third customer lists do not have the second-type IDs, combining data of the to-be-processed customer lists and data of the third customer lists; and
if the third customer lists have the second-type IDs, creating second new lists in the valid customer database, saving data of the to-be-processed customer lists in the second new lists, and clearing the third-type IDs of the third customer lists.

12. The list deduplication method of claim 11, wherein the step of refreshing the second customer lists according to the to-be-processed database comprises:
matching first to-be-processed customer lists; wherein the first-type IDs of the first to-be-processed customer lists are the same as the first-type IDs of the second customer lists in the to-be-processed database; and
after finding the first to-be-processed customer lists, updating the second customer lists according to the first to-be-processed customer lists.

13. The list deduplication method of claim 9, further comprising, after step A2, the following steps:
if the to-be-processed customer lists do not have the first-type IDs, looking up fourth customer lists, wherein second-type IDs or third-type IDs of the fourth customer lists are the same as the second-type IDs of the to-be-processed customer lists or third-type IDs of the to-be-processed customer lists in the valid customer database;
if the fourth customer lists are not found, creating third new lists in the valid customer database, and saving the data of the to-be-processed customer lists in the new lists; and
if the fourth customer lists are found, deduplicating the to-be-processed customer lists.

14. The list deduplication method of claim 13, wherein the step of refreshing the second customer lists according to the to-be-processed database comprises:
matching first to-be-processed customer lists; wherein the first-type IDs of the first to-be-processed customer lists are the same as the first-type IDs of the second customer lists in the to-be-processed database; and
after finding the first to-be-processed customer lists, updating the second customer lists according to the first to-be-processed customer lists.

15. The list deduplication method of claim 9, wherein, after step D2, a processor is further configured to execute a list deduplication system to implement the following step:
if the second customer lists do not have the first-type IDs, updating the second customer lists according to the data of the to-be-processed database.

16. The list deduplication method of claim 15, wherein the step of refreshing the second customer lists according to the to-be-processed database comprises:
matching first to-be-processed customer lists; wherein the first-type IDs of the first to-be-processed customer lists are the same as the first-type IDs of the second customer lists in the to-be-processed database; and
after finding the first to-be-processed customer lists, updating the second customer lists according to the first to-be-processed customer lists.

17. A computer-readable storage medium, storing an information query control system, wherein the information query control system may be executed by at least one processor to allow the at least one processor to execute the following operation:
step A3: acquiring to-be-processed customer lists one by one from a to-be-processed database, and analyzing whether the to-be-processed customer lists have first-type Identifiers (IDs) or not;
step B3: if the to-be-processed customer lists have the first-type IDs, looking up first customer lists, wherein the first-type Ids of the first customer lists are the same as the first-type IDs of the to-be-processed customer lists in a valid customer database;
step C3: if the first customer lists are not found, looking up second customer lists, wherein second-type IDs of the second customer lists are the same as second-type IDs of the to-be-processed customer lists in the valid customer database;
step D3: if the second customer lists are found, checking whether the second customer lists have the first-type IDs or not;
step E3: if the second customer lists have the first-type IDs, refreshing the second customer lists according to the to-be-processed database, and then comparing the second-type IDs of the to-be-processed customer lists with the second-type IDs of the second customer lists; and
step F1: if the second-type IDs of the to-be-processed customer lists are the same as the second-type IDs of the second customer lists, deduplicating the to-be-processed customer lists.

18. The computer-readable storage medium of claim 17, wherein, after step E3, the processor is further configured to execute a list deduplication system to implement the following steps:
if the second-type IDs of the to-be-processed customer lists are different from the second-type IDs of the second customer lists, searching the valid customer database for third customer lists, wherein third-type IDs of the third customer lists are the same as the second-type IDs of the to-be-processed customer lists;
if the third customer lists are not found in the valid customer database, creating first new lists in the valid customer database, and saving data of the to-be-processed customer lists in the first new lists;
if the third customer lists are found in the valid customer database, analyzing whether the third customer lists have second-type IDs or not;
if the third customer lists do not have the second-type IDs, combining data of the to-be-processed customer lists and data of the third customer lists; and
if the third customer lists have the second-type IDs, creating second new lists in the valid customer database, saving data of the to-be-processed customer lists in the second new lists, and clearing the third-type IDs of the third customer lists.

19. The computer-readable storage medium of claim 17, wherein, after step A3, the processor is further configured to execute the list deduplication system to implement the following steps:
if the to-be-processed customer lists do not have the first-type IDs, looking up fourth customer lists, wherein second-type IDs or third-type IDs of the fourth customer lists are the same as the second-type IDs of the to-be-processed customer lists or third-type IDs of the to-be-processed customer lists in the valid customer database;
if the fourth customer lists are not found, creating third new lists in the valid customer database, and saving the data of the to-be-processed customer lists in the new lists; and
if the fourth customer lists are found, deduplicating the to-be-processed customer lists.

20. The computer-readable storage medium of claim 17, wherein the step of refreshing the second customer lists according to the to-be-processed database comprises:
matching first to-be-processed customer lists; wherein the first-type IDs of the first to-be-processed customer lists are the same as the first-type IDs of the second customer lists in the to-be-processed database; and
after finding the first to-be-processed customer lists, updating the second customer lists according to the first to-be-processed customer lists.
